(19) United States
(12) Patent Application Publication
(10) Pub. No.: US 2025/0237847 A1
(43) Pub. Date: Jul. 24, 2025

(54) CAMERA MODULE DRIVING APPARATUS

(71) Applicant: Samsung Electro-Mechanics Co., Ltd., Suwon-si (KR)

(72) Inventor: Youn Joong LEE, Suwon-si (KR)

(73) Assignee: Samsung Electro-Mechanics Co., Ltd., Suwon-si (KR)

(21) Appl. No.: 18/980,966

(22) Filed: Dec. 13, 2024

(30) Foreign Application Priority Data
Jan. 22, 2024 (KR) 10-2024-0009299

(51) Int. Cl. G02B 7/10; G02B 7/09; G03B 3/10

(52) U.S. Cl. CPC G02B 7/102; G02B 7/09; G03B 3/10

(57) ABSTRACT

A camera module driving apparatus is provided. The camera module driving apparatus includes a camera module driving integrated circuit (IC) including a communication port, a driving port, and a power port; a driver configured to output a driving current based on a set driving strength within the camera module driving IC; and a driving strength optimizer configured to sense a voltage of a power provided to at least one of the communication port and the power port within the camera module driving IC, and set the driver to a driving strength corresponding to the voltage of the power supply; and the driving strength optimizer is configured to be in a paused state while changing the driving strength setting of the driver as the voltage of the power is changed so that the corresponding driving strength is changed.

### CROSS-REFERENCE TO RELATED APPLICATIONS

This application claims the benefit under 35 USC § 119 (a) of Korean Patent Application No. 10-2024-0009299 filed on Jan. 22, 2024, in the Korean Intellectual Property Office, the entire disclosure of which is incorporated herein by reference for all purposes.

### BACKGROUND

### 1. Field

The following description relates to a camera module driving apparatus.

### 2. Description of Related Art

Typically, a device may include a camera, such as a camera module, for which a position of a lens thereof needs to be controlled, and the position of the lens, which may be included in the camera module, may be controlled based on a driving signal.

An Integrated Circuit (IC) may be provided to generate the driving signal. The importance of reducing power consumption and the miniaturization/simplification of the IC is gradually increasing.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module driving apparatus includes a camera module driving integrated circuit (IC) comprising a communication port, a driving port and a power port; a driver configured to output a driving current based on a set driving strength in the camera module driving IC; and a driving strength optimizer configured to sense a voltage of power provided to at least one of the communication port and the power port in the camera module driving IC, and configured to set the driver to have a driving strength corresponding to the voltage of the power, wherein the driving strength optimizer is configured to be in a paused state while changing the setting of the driving strength of the driver, when the voltage of the power is changed such that the corresponding driving strength is changed.

The driving strength optimizer may be configured to resume an operational state after being in the paused state.

The driving strength optimizer may include a comparator configured to sense the voltage of the power and output a value based on the sensed voltage; and a latch configured to receive the output value based on the sensed voltage, and output a set value of the driving strength of the driver; wherein the driving strength optimizer may be configured to be paused based on a change in value that is based on the sensed voltage input through a first input terminal among a plurality of input terminals of the latch, and may be configured to resume an operational state based on a value input through a second input terminal of the plurality of input terminals.

The driving strength optimizer may include a comparator configured to sense the voltage of the power and output a value based on the sensed voltage; and a latch configured to receive the value based on the sensed voltage, and output a set value of the driving strength of the driver; wherein the driving strength optimizer is configured to be paused based on a change in value that is based on the sensed voltage input through a first input terminal among a plurality of input terminals of the latch.

The driving strength optimizer may further include a plurality of resistors configured to reduce the voltage of the power by a predetermined ratio and output the reduced voltage of the power to the comparator, and the comparator may be configured to output a value based on a high-low relationship between a voltage output from the plurality of resistors and a reference voltage, as the output value based on the sensed voltage.

The camera module driving apparatus may further include an interface configured to receive a communication signal through the communication port of the camera module driving IC, wherein the interface may be configured to transmit a communication signal through the communication port based on the driving current of the driver, and the driving strength optimizer may be configured to sense the voltage of the power provided to the communication port.

The camera module driving apparatus may further include an interface configured to receive a communication signal through the communication port of the camera module driving IC; and a controller configured to control the driving current of the driver based on the received communication signal, wherein the driver may be configured to output the driving current in which a ratio that is based on the set driving strength is applied to a current value determined by the controller.

The driver may include first driving semiconductor circuit elements coupled in a bridge structure; and second driving semiconductor circuit elements coupled in a bridge structure; wherein the driver may be configured to switch between an operation of at least one of the first driving semiconductor circuit elements and the second driving semiconductor circuit elements, based on the set driving strength.

A size (W/L) of each of the first driving semiconductor circuit elements may be larger than a size (W/L) of each of the second driving semiconductor circuit elements.

The driver may include first driving semiconductor circuit elements coupled in a bridge structure; second driving semiconductor circuit elements coupled in a bridge structure; and third driving semiconductor circuit elements coupled in a bridge structure; wherein the driver is configured to switch between an operation of at least two of the first driving semiconductor circuit elements, the second driving semiconductor circuit elements, and the third driving semiconductor circuit elements, based on the set driving strength, wherein a size of each of the third driving semiconductor circuit elements is 1.6 times or more and 2.4 times or less than a size of each of the first driving semiconductor circuit elements, and 1.6 times or more and 2.4 times or less than a size of each of the second driving semiconductor circuit elements, and wherein the size of each of the first driving semiconductor circuit elements is 0.8 times or more and 1.2 times or less than the size of each of the second driving semiconductor circuit elements.

In the driver, when set to have a first driving strength, a first set of the first driving semiconductor circuit elements or the second driving semiconductor circuit elements is turned on, a second set of the first driving semiconductor circuit elements or the second driving semiconductor circuit elements may be turned off, and the third driving semiconductor circuit elements are turned off, wherein when set to have a second driving strength, the first driving semiconductor circuit elements and the second driving semiconductor circuit elements are turned on, and the third driving semiconductor circuit elements are turned off, or the first driving semiconductor circuit elements and the second driving semiconductor circuit elements may be turned off, and the third driving semiconductor circuit elements are turned on, wherein when set to have a third driving strength, a first set of the first driving semiconductor circuit elements or the second driving semiconductor circuit elements is turned on, a second set of the first driving semiconductor circuit elements or the second driving semiconductor circuit elements is turned off, and the third driving semiconductor circuit elements are turned on, and wherein when set to have a fourth driving strength, the first driving semiconductor circuit elements, the second driving semiconductor circuit elements, and the third driving semiconductor circuit elements are turned on.

In a general aspect, a camera module driving apparatus includes a camera module driving integrated circuit (IC) comprising a communication port, a driving port and a power port; a driver configured to output a driving current based on a set driving strength in the camera module driving IC; and a driving strength optimizer configured to sense a voltage of power provided to at least one of the communication port and the power port in the camera module driving IC, and configured to set the driver to have a driving strength corresponding to the voltage of the power, wherein the driving strength optimizer includes a comparator configured to sense the voltage of the power and output a value based on the sensed voltage; and a latch configured to receive the output value based on the sensed voltage, and output a set value of the driving strength of the driver.

The driving strength optimizer further may further include a plurality of resistors configured to reduce the voltage of the power by a predetermined ratio and output the reduced voltage of the power to the comparator, and the comparator may be configured to output a value based on a high-low relationship between a voltage output from the plurality of resistors and a reference voltage as the output value based on the sensed voltage.

The camera module driving apparatus may further include an interface configured to receive a communication signal through the communication port of the camera module driving IC, wherein the interface is configured to transmit a communication signal through the communication port based on the driving current of the driver, and wherein the driving strength optimizer is configured to sense the voltage of the power provided to the communication port.

The camera module driving apparatus may further include an interface configured to receive a communication signal through the communication port of the camera module driving IC; and a controller configured to control the driving current of the driver based on the received communication signal; wherein the driver is configured to output the driving current in which a ratio that is based on the set driving strength is applied to a current value determined by the controller.

The driver may include first driving semiconductor circuit elements coupled in a bridge structure; and second driving semiconductor circuit elements coupled in a bridge structure, wherein the driver is configured to switch between an operation of at least one of the first driving semiconductor circuit elements and the second driving semiconductor circuit elements, based on the set driving strength.

Other features and aspects will be apparent from the following detailed description, the drawings, and the claims.

### BRIEF DESCRIPTION OF DRAWINGS

FIG. 1 illustrates an example camera module driving apparatus and an example device including a camera module, in accordance with one or more embodiments.

FIGS. 2A and 2B illustrate an example camera module driving apparatus, in accordance with one or more embodiments, optimizing the driving strength of a first driver (included in the driver).

FIGS. 3A and 3B illustrate an example camera module driving apparatus, in accordance with one or more embodiments, optimizing the driving strength of a second driver (included in the driver).

FIGS. 4A and 4B are circuit diagrams illustrating a driver of an example camera module driving apparatus, in accordance with one or more embodiments.

FIG. 5A illustrates a correspondence relationship between a driving strength setting value of a driver of an example camera module driving apparatus, in accordance with one or more embodiments, and on/off states of first, second, and third driving semiconductor circuit elements.

FIGS. 5B and 5C are graphs illustrating the driving current of the driver according to the corresponding relationship of FIG. 5A.

FIG. 6A, FIG. 6B, FIG. 6C, FIG. 6D, and FIG. 6E are circuit diagrams illustrating an example camera module driving apparatus, in accordance with one or more embodiments.

FIG. 7 is a graph illustrating a timing of change in voltage of power provided through a port, the timing of change in voltage of power of a camera module driving IC, and the timing of return of the driving strength optimizer.

FIG. 8 is a flowchart illustrating an operation sequence of an example camera module driving apparatus, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may provide a camera module driving apparatus that stably optimizes a driving strength of a driver according to a change in a voltage of a provided power source.

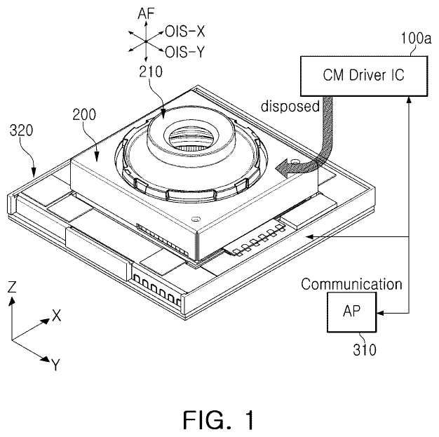

Referring to FIG. 1, an example camera module driving apparatus according to an embodiment of the present disclosure may include a camera module driver IC (100a). A device including a camera module driving apparatus may further include a camera module (200), a processor (310), and an image sensor (320).

In an example, the device may be, but is not limited to, a vehicle, a smartphone, a personal digital assistant, a digital video camera, a digital still camera, a network system, a computer, a monitor, a tablet, a laptop, a netbook, a television, a video game, a smartwatch, an automotive component, etc.

The camera module (200) may include a lens (210) whose position may be controlled based on a driving current of the camera module driving IC (100a). In an example, the lens (210) may be implemented as a lens module in which a plurality of lenses may be arranged, may be disposed in a center of the camera module (200), and may include a permanent magnet so that the position is controlled by a magnetic field. The position of the lens (210) may be controlled in a Z-axis direction by autofocus (AF) control, and may be controlled in a X-axis or a Y-axis direction by optical image stabilization (OIS-X, OIS-Y) control. In an example, the camera module (200) may include a position sensor such as a hall sensor and an acceleration sensor such as a gyro sensor, and may control the position of the lens (210) based on the detection results of the position sensor and the acceleration sensor.

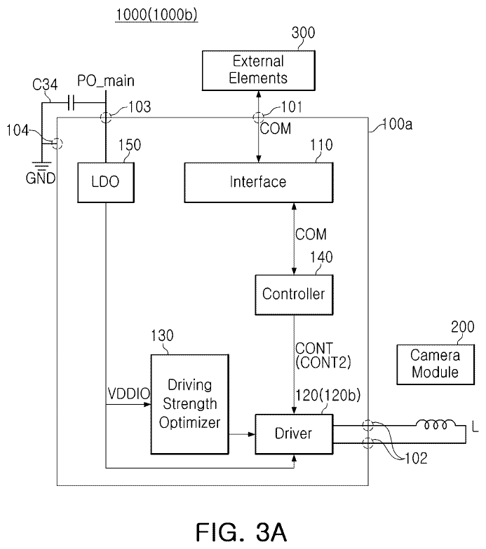

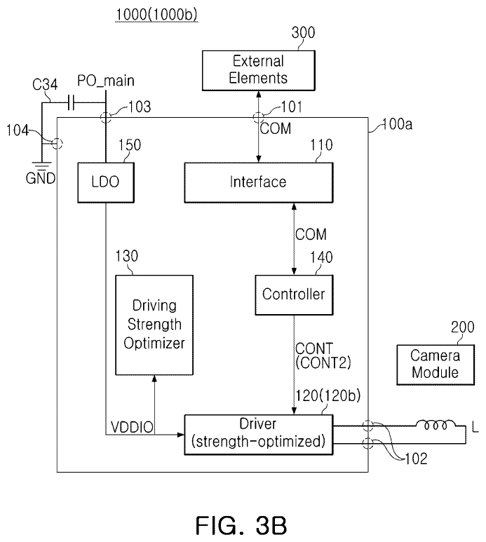

In an example, the camera module (200) may include a printed circuit board, and a driving coil (L) illustrated in FIGS. 3A and 3B may be disposed on the printed circuit board within the camera module (200). In an example, the camera module driving IC (100a) may also be disposed on a printed circuit board and may be disposed at a position surrounded by a winding of the driving coil (L).

The image sensor (320) may generate an image by receiving light passing through the lens (210). In an example, the image sensor (320) may include a CMOS image sensor and may include an image sensor package that provides a placement space for the CMOS image sensor. In an example, the camera module (200) may be disposed on the Z-axis upper surface of the image sensor package, and the CMOS image sensor may be disposed between the image sensor package and the camera module (200).

Depending on the implementation, the camera module driving IC (100a) may output a driving current to control a position of the image sensor (320) instead of the lens (210). In an example, the image sensor (320) may be one of a component included in the camera module (200). A method to control the position of the lens (210) may be a lens shift method, and a method to control the position of the image sensor (320) may be a sensor shift method. The camera module driving IC (100a) may output a driving current based on a lens shift method and/or a sensor shift method.

At least one of the processor (310) and the image sensor (320) may transmit a communication signal to a camera module driving apparatus including the camera module driving IC (100a). The camera module driving IC (100a) may receive the communication signal through the interface (110).

The processor (310) may receive an image from the image sensor (320). In an example, the processor (310) may be an Application Processor (AP) configured to perform a specific application in the device. In a non-limited example, the AP may be an Image Signal Processor (ISP). Alternatively, if the device is relatively small in size, the processor (310) may be a processor (e.g., main processor, core processor) controlling the overall operation of the device.

A device including a camera module driving apparatus, in accordance with one or more embodiments, may include an IC power system and a first power system, and may further include a second power system based on the implementation. In an example, the IC power system, the first power system, and the second power system may be used as paths through which the IC power (e.g., 2.8 V), the first power (e.g., 1.2 V), and the second power (e.g., 1.8 V) supplied from the PMIC, respectively.

In an example, the IC power system may be connected to the camera module driving IC (100a) and/or an additional driver, and the first and second power systems may be connected to the processor (310), the image sensor (320), the gyro sensor, a pull-up resistor, and an Electrically Erasable Programmable Read-Only Memory (EEPROM).

Communication between at least two of the camera module driving IC (100a), processor (310), image sensor (320), gyro sensor, additional driver, and EEPROM may be configured based on at least one of I2C (Inter-Integrated Circuit), Serial Peripheral Interface (SPI), Mobile Industry Processor Interface (MIPI), and General-Purpose Input/Output (GPIO).

In an example, a communication between the camera module driving IC (100a) and the processor (310) may be based on I2C, a communication between the camera module driving IC (100a) and the image sensor (320) may be based on GPIO, a communication between the camera module driving IC (100a) and the gyro sensor may be based on SPI, and a communication between the processor (310) and the image sensor (320) may be based on MIPI.

In an example, a device including a camera module driving apparatus, in accordance with one or more embodiments, may include a first power system and a second power system. MIPI may be based on a first power system, and I2C, GPIO, and SPI may be based on a second power system. Since the camera module driving IC (100a) may transmit and receive a communication signal based on at least one of I2C, GPIO, and SPI, a voltage level (e.g., 1.8 V) of the communication signal based on the second power system that the camera module driving IC (100a) transmits and receives may be higher than a voltage level (e.g., 1.2 V) of the first power system, and thus may be high. Accordingly, the level of power (e.g., 1.8 V) used by the camera module driving IC (100a) to output driving current may also be high, and the driving current may increase overall.

In an example, a device including a camera module driving apparatus, in accordance with one or more embodiments, may include a first power system. I2C, GPIO, SPI, MIPI may be based on the first power system. Since the camera module driving IC (100a) may transmit and receive a communication signal based on at least one of I2C, GPIO, SPI, and MIPI, the voltage level (e.g., 1.2 V) of the communication signal based on the first power system transmitted and received by the camera module driving IC (100a) may be low. Accordingly, the level of power (e.g., 1.2 V) used by the camera module driving IC (100a) to output driving current may also be low, and the driving current may become smaller overall.

Whether the device including the camera module driving apparatus, in accordance with one or more embodiments, uses the first and second power systems, whether it uses an additional power system, or whether the change in the voltage levels of the first and second power systems may vary depending on the implementation of the device. From an implementation perspective of the camera module driving IC (100a), implementation or manufacturing information of the device may be uncertain information.

Accordingly, the camera module driving IC (100a) may efficiently optimize the output driving current by responding flexibly to the uncertainty of the device implementation information. In an example, when the camera module driving IC (100a) outputs a driving current based on a relatively high voltage level (e.g., 1.8 V) of the second power system, the camera module driving IC (100a) may optimize the driving current by lowering the driving current intensity. In an example, when the camera module driving IC (100a) outputs a driving current based on a relatively low voltage level (e.g., 1.2 V) of the first power system, the camera module driving IC (100a) may optimize the driving current by increasing the driving current intensity.

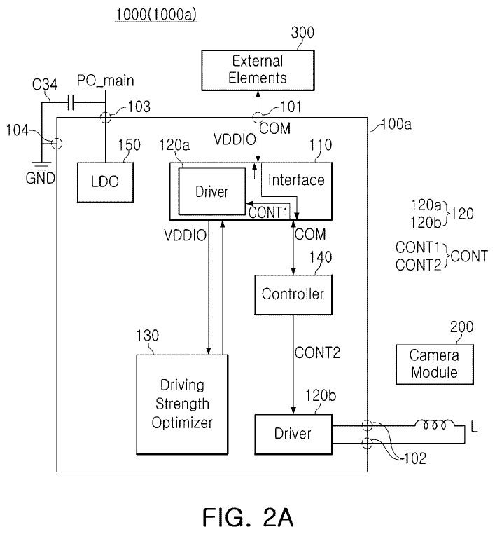

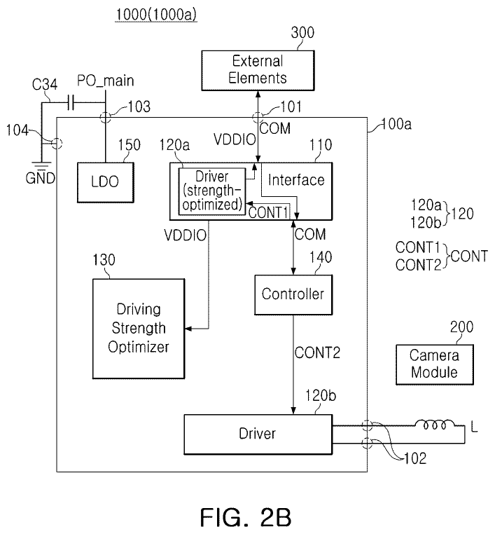

FIG. 2A is a block diagram illustrating a structure in a driving strength optimizer (130) of a camera module driving apparatus (1000a), in accordance with one or more embodiments, which optimizes the driving strength of a first driver (120a), and FIG. 2B is a block diagram illustrating a pause of the driving strength optimizer (130) of the camera module driving apparatus (1000a). FIG. 3A is a block diagram illustrating a structure in the driving strength optimizer (130) of a camera module driving apparatus (1000b), in accordance with one or more embodiments, optimizes the driving strength of a second driver (120b), and FIG. 3B is a block diagram illustrating a pause of the driving strength optimizer (130) of the camera module driving apparatus (1000b).

Referring to FIGS. 2A, 2B, 3A, and 3B, a camera module driving apparatus (1000, 1000a, 1000b), in accordance with one or more embodiments, may include the camera module driving IC (100a), a driver (120), and the driving strength optimizer (130).

The camera module driving IC (100a) may include a communication port (101), a driving port (102), and a power port (103). In an example, the communication port (101), the driving port (102), and the power port (103) may be implemented as pins or pads disposed on a typical semiconductor chip as electrical paths.

The communication port (101) may be an electrical path through which a communication signal (COM) transmitted and received between the camera module driving IC (100a) and external elements (300) passes. For example, the external elements (300) may be at least one of a processor, an image sensor, and a gyro sensor disposed in the device (1000).

The drive port (102) may be electrically connected to the driving coil (L) disposed outside the camera module driving IC (100a) and may be an electrical path through which the driving current flows. When the driving current flows through the driving coil (L), the driving coil (L) may form the magnetic field, and the position of the lens of the camera module (200) may be controlled by the Lorentz force based on the magnetic field.

The power port (103) may be electrically connected to the IC power system (PO_main). For example, the IC power system (PO_main) may be generated by a PMIC (Power Management Integrated Circuit) disposed in the device, may be a relatively high voltage (e.g., 2.8 V), may be a main power source of the camera module driving IC (100a), and may be used as energy necessary for multiple operations of the camera module driving IC (100a). In an example, a capacitor (C34) may be connected between the power port (103) and the ground port (104) and may stabilize the IC power system (PO_main).

At least one of the communication port (101) and the power port (103) may include an electrical path through which power supply (VDDIO) provided from outside to inside of the camera module driving IC (100a) passes. The power supply (VDDIO) may be a second power (e.g. 1.8 V) based on the second power system, or a first power (e.g. 1.2 V) based on the first power system.

The driver (120) may be configured to output the driving current based on a set driving strength within the camera module driving IC (100a). The driving strength optimizer (130) may be configured to sense the voltage of the power supply (VDDIO) within the camera module driving IC (100a) and set the driver (120) to a driving strength corresponding to the voltage of the power supply (VDDIO). For example, when the power supply (VDDIO) is a second power (e.g., 1.8 V) based on the second power system, the driving strength optimizer (130) may output a low driving strength setting value (or a high driving strength setting value) to the driver (120) to lower the driving strength of the driver (120).

For example, when the power supply (VDDIO) is a first power (e.g., 1.2 V) based on the first power system, the driving strength optimizer (130) may output a high drive strength setting value (or a low drive strength setting value) to the driver (120) to increase the drive strength of the driver (120). Accordingly, an overall size of the driving current output by the driver (120) may be insensitive to changes in the voltage level of the power supply (VDDIO), and thus may respond flexibly to uncertainty in the voltage level of the power supply (VDDIO).

In an example, when the overall size of the driving current output by the driver (120) is too large, overshoot or undershoot of the driving current may occur. Overshoot and undershoot of the driving current may be noise factors in the communication signal (COM) transmitted and received between the camera module driving IC (100a) and external elements (300).

In an example, if the overall magnitude of the driving current output by the driver (120) is too low, a rising time and falling time of the driving current may become excessively long. When the rising time and falling time are excessively long, it may be difficult to secure the stability of a lens position control of the camera module (200) or it may be difficult to secure a performance of the communication signal (COM) (e.g., data transmission/reception rate, bit error rate, etc.).

However, since the camera module driving apparatus (1000, 1000a, 1000b), in accordance with one or more embodiments, may optimize the overall size of the driving current, it may prevent overshoot and undershoot of the driving current, reduce noise of the communication signal (COM), and prevent the rising time and falling time from becoming excessively long.

Referring to FIGS. 2B and 3B, the driving strength optimizer (130) may be configured to pause while changing the drive strength setting of the driver (120) as the voltage of the power supply (VDDIO) changes so that the corresponding drive strength changes. For example, the driving strength optimizer (130) in a paused state may maintain the driving strength setting value output to the driver (120), may prevent the driving strength setting value from being affected by the voltage of the power supply (VDDIO), or may not sense the voltage of the power supply (VDDIO).

Therefore, the driver (120) may stably perform the driving strength setting operation after receiving the driving strength setting value changed by the driving strength optimizer (130), may stably optimize the driving strength, and may prevent malfunction during the driving strength optimizer process.

In an example, immediately after the voltage level of the power supply (VDDIO) is changed, the power supply (VDDIO) may be temporarily unstable, but an instability of the power supply (VDDIO) may not substantially affect the driving strength setting operation of the driver (120). Therefore, the driver (120) may stably perform the driving strength setting operation.

In an example, even if the power supply (VDDIO) may be the power supply of a switched mode power supply (SMPS), the fluctuations in the power supply (VDDIO) may not substantially affect the driving strength setting operation of the driver (120). Therefore, the driver (120) may stably perform the driving strength setting operation.

When the driving strength setting operation of the driver (120) is completed or stabilized, the driving strength optimizer (130) may be configured to resume after being in a paused state. Accordingly, the driving strength optimizer (130) may reset the driving strength of the driver (120) as the voltage level of the power supply (VDDIO) may be changed again. For example, a time from a time the driving strength optimizer (130) being in a paused state to a time it resumes may be a time that is preset by a timer or a time that is naturally determined by the load during the driving strength setting operation process.

Referring to FIGS. 2A, 2B, 3A and 3B, a camera module driving apparatus (1000, 1000a, 1000b), in accordance with one or more embodiments, may further include at least one of an interface (110), a controller (140) and a voltage generator (150).

The voltage generator (150) may include an LDO (Low Dropout) circuit and may lower the voltage of the IC power system (PO_main) to a set voltage. In an example, the set voltage may be a bias voltage that may be used overall in the camera module driving IC (100a) and may also provide power supply (VDDIO of FIGS. 3A and 3B) to the second driver (120b).

The interface (110) may receive the communication signal (COM) through the communication port (101) in the camera module driving IC (100a). In an example, the interface (110) may be implemented as an I/O (Input/Output) of a typical integrated circuit and may be configured to process transmission and reception of the communication signal (COM).

The interface (110) may receive power supply (VDDIO) from an outside of the camera module driving IC (100a) through the communication port (101). The interface (110) may operate based on power supply (VDDIO) and may deliver the power supply (VDDIO) to the driving strength optimizer (130). The driving strength optimizer (130) may sense the voltage of the power supply (VDDIO).

In an example, by using the communication signal (COM) received through the interface (110), the camera module driving IC (100a) may be synchronized with external elements (300), receive information necessary to determine the target position of the lens of the camera module through the processor of the external elements (300), receive feedback information from the image sensor of the external elements (300), or receive acceleration information necessary to determine the driving current flowing in the driving coil (L) from the gyro sensor of the external elements (300). In an example, at least a portion of the communication signal (COM) received through the interface (110) may be a pulse waveform.

The controller (140) may control the driving current of the driver (120) based on the communication signal (COM). For example, the controller (140) may perform the overall digital processing operation of the camera module driving IC (100a). For example, the controller (140) may store or load autofocus control logic or optical image stabilization control logic, may perform calculations by applying information to the above control logics, and may control the second driver (120b) based on the calculation results.

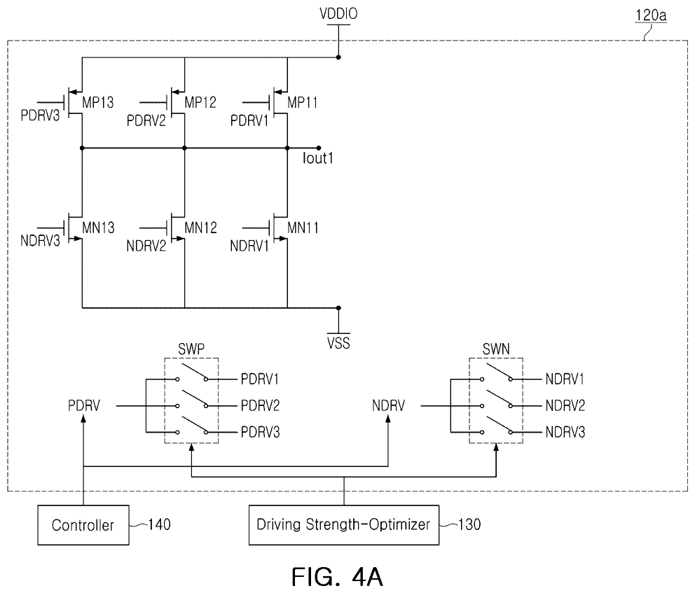

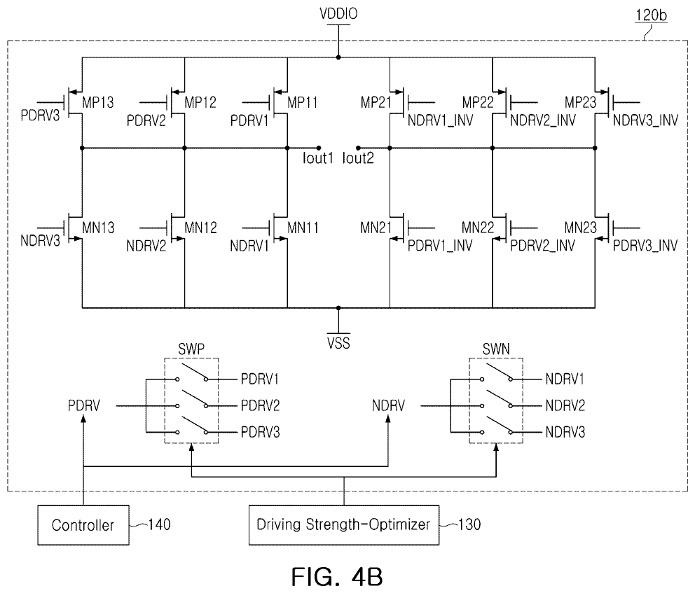

The driver (120) may output a driving current applying a ratio according to the set driving strength to a current value determined by the controller (140). For example, the controller (140) may determine a control value (CONT) and provide it to the driver (120). The control value (CONT) may be the control value (PDRV, NDRV) of FIG. 4A and FIG. 4B, and may include a first control value (CONT1) and/or a second control value (CONT2).

In an example, the driver (120) may include the first driver (120a) and/or the second driver (120b). The first driver (120a) may be included in the interface (110), and the interface (110) may use the driving current output by the first driver (120a). For example, the first driver (120a) may receive the first control value (CONT1) from the controller (140) and output a driving current based on the first control value (CONT1). The interface (110) may transmit a communication signal based on a driving current whose driving strength is optimized by the driving strength optimizer (130) to external elements (300) through the communication port (101). Accordingly, a noise given to the device by the communication signal transmitted by the camera module driving apparatus (1000a) may be reduced, and the performance of the communication signal may be stably secured.

In an example, the second driver (120b) may receive a second control value (CONT2) from the controller (140) and output a driving current through the driving port (102) based on the second control value (CONT2). Since the driving strength of the driving current may be optimized by the driving strength optimizer (130), the noise that the camera module driving apparatus (1000a) gives to the device during the process of controlling the position of the lens of the camera module (200) may be reduced. Additionally, since the rising time and falling time of the driving current may be prevented from becoming excessively long, the stability/efficiency of the position control of the lens of the camera module (200) may be stably secured.

FIG. 4A and FIG. 4B are circuit diagrams illustrating the first and second drivers (120a, 120b) of the camera module driving apparatus, in accordance with one or more embodiments, FIG. 4A illustrates a structure in which the first driver (120a) outputs current (Iout1) through a single output terminal, and FIG. 4B illustrates a structure in which the second driver (120b) outputs current (Iout1, Iout2) through a differential output terminal, but is not limited thereto. For example, when a communication standard of the camera module driving apparatus requires a differential signal, the first driver (120a) may be implemented with a structure that outputs current through the differential output terminal. In an example, depending on a specific structure of the camera module (200 in FIG. 1) of the camera module driving apparatus, the second driver (120b) may be implemented with a structure outputting current through the single output terminal.

Referring to FIGS. 4A and 4B, the driver (120a, 120b) may receive control values (PDRV, NDRV) from the controller (140) and generate control values (PDRV1, PDRV2, PDRV3, NDRV1, NDRV2, NDRV3) according to the control values (PDRV, NDRV). The driver (120a, 120b) may include switches (SWP, SWN) to switch whether to generate each of the control values (PDRV1, PDRV2, PDRV3, NDRV1, NDRV2, NDRV3). The control values (PDRV, NDRV) may be seeds of currents (Iout1, Iout2).

The driving strength optimizer (130) may output the driving strength setting value, and on-off state of the switches (SWP, SWN) may be determined based on the driving strength setting value. In an example, each of the switches (SWP, SWN) may be implemented as a transistor, the driving strength setting value may be output to a gate terminal of the transistor, and the on-off state of an electrical path between a drain terminal and a source terminal of the transistor may be determined according to the voltage of the gate terminal.

The driver (120a, 120b) may include first driving semiconductor circuit elements (MN11, MP11, MN21, MP21) coupled in a bridge structure, second driving semiconductor circuit elements (MN12, MP12, MN22, MP22) coupled in a bridge structure, and may further include third driving semiconductor circuit elements (MN13, MP13, MN23, MP23) coupled in a bridge structure. In an example, the bridge structure may be one of an H-bridge, a half-bridge, and a full-bridge. In an example, depending on the type of bridge structure, a portion of the first driving semiconductor circuit elements (MN21, MP21), the second driving semiconductor circuit elements (MN22, MP22), and the third driving semiconductor circuit elements (MN23, MP23) may be omitted.

In an example, each of the first driving semiconductor circuit elements (MN11, MP11, MN21, MP21), the second driving semiconductor circuit elements (MN12, MP12, MN22, MP22), and the third driving semiconductor circuit elements (MN13, MP13, MN23, MP23) may include a driving transistor (e.g., NMOS, PMOS), and may further include a diode connected between the drain terminal and the source terminal of the driving transistor, depending on the design. At least a portion of the control values (PDRV1, PDRV2, PDRV3, NDRV1, NDRV2, NDRV3) may be transmitted to the gate terminal of the driving transistor, and the current between the drain terminal and the source terminal of the driving transistor may be determined by at least a portion of the control values (PDRV1, PDRV2, PDRV3, NDRV1, NDRV2, NDRV3).

In an example, the control values (PDRV1_INV, PDRV2_INV, PDRV3_INV, NDRV1_INV, NDRV2_INV, NDRV3_INV) may be output values according to inputting the control values (PDRV1, PDRV2, PDRV3, NDRV1, NDRV2, NDRV3) to the CMOS inverters. The driver (120) may also include the CMOS inverters.

A sum of the first driving current of the first driving semiconductor circuit elements (MN11, MP11, MN21, MP21), the second driving current of the second driving semiconductor circuit elements (MN12, MP12, MN22, MP22), and the third driving current of the third driving semiconductor circuit elements (MN13, MP13, MN23, MP23) may be current (Iout1, Iout2). Therefore, a switching of use of the first driving semiconductor circuit elements (MN11, MP11, MN21, MP21), a switching of use of the second driving semiconductor circuit elements (MN12, MP12, MN22, MP22), and a switching of use of the third driving semiconductor circuit elements (MN13, MP13, MN23, MP23) may be a switching of the overall size of the driving current of the driver (120a, 120b) and a switching of the driving current intensity of the driver (120a, 120b).

The driver (120a, 120b) may switch to use at least one of the first driving semiconductor circuit elements (MN11, MP11, MN21, MP21) and the second driving semiconductor circuit elements (MN12, MP12, MN22, MP22) according to the set driving strength, and may further switch to use the third driving semiconductor circuit elements (MN13, MP13, MN23, MP23) according to the implementation. In an example, the drivers (120a, 120b) may determine the on-off state of the switches (SWP, SWN) based on the driving strength setting value input from the driving strength optimizer (130), generate each of the control values (PDRV1, PDRV2, PDRV3, NDRV1, NDRV2, NDRV3) according to the on-off state of the switches (SWP, SWN), and use the first driving semiconductor circuit elements (MN11, MP11, MN21, MP21), the second driving semiconductor circuit elements (MN12, MP12, MN22, MP22), and the third driving semiconductor circuit elements (MN13, MP13, MN23, MP23) according to a determination to generate each of the control values (PDRV1, PDRV2, PDRV3, NDRV1, NDRV2, NDRV3).

The driving current (Iout1, Iout2) of the driver (120a, 120b) may be proportional to the difference between the voltage level of the power supply (VDDIO) and the voltage level of a low voltage (VSS). In an example, the low voltage (VSS) may be a ground voltage or a voltage generated by the voltage generator (150) of FIG. 3A. The power supply (VDDIO) may be the second power supply (e.g. 1.8 V) based on the second power supply system, or a first power supply (e.g. 1.2 V) based on the first power supply system. In an example, when the power supply (VDDIO) is a secondary power supply (e.g., 1.8 V), a portion of the control values (PDRV1, PDRV2, PDRV3, NDRV1, NDRV2, NDRV3) may not be used, and the driving strength of the drivers (120a, 120b) may be reduced. In an example, when the power supply (VDDIO) is a primary power supply (e.g., 1.2 V), the control values (PDRV1, PDRV2, PDRV3, NDRV1, NDRV2, NDRV3) may all be used, and the driving strength of the driver (120a, 120b) may be increased.

In an example, a size (W/L) of each of the first driving semiconductor circuit elements (MN11, MP11, MN21, MP21) may be larger than a size (W/L) of each of the second driving semiconductor circuit elements (MN12, MP12, MN22, MP22). Accordingly, the number of examples of the total driving current of the first driving semiconductor circuit elements (MN11, MP11, MN21, MP21) and the second driving semiconductor circuit elements (MN12, MP12, MN22, MP22) may vary, so that the driving strength of the driver (120a, 120b) may be set more precisely. The size (W/L) may be the width divided by the length of the electrical path (e.g. channel) formed between the drain and source terminals of the transistor, and the current flowing between the drain and source terminals may be proportional to the size (W/L).

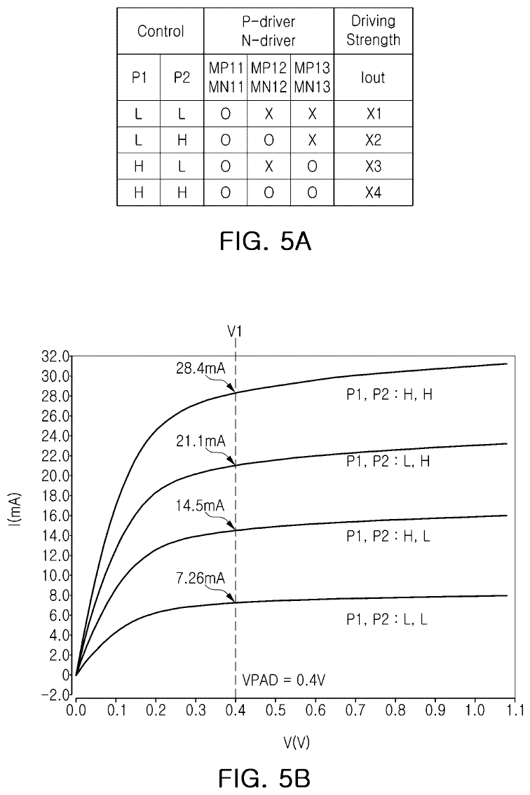

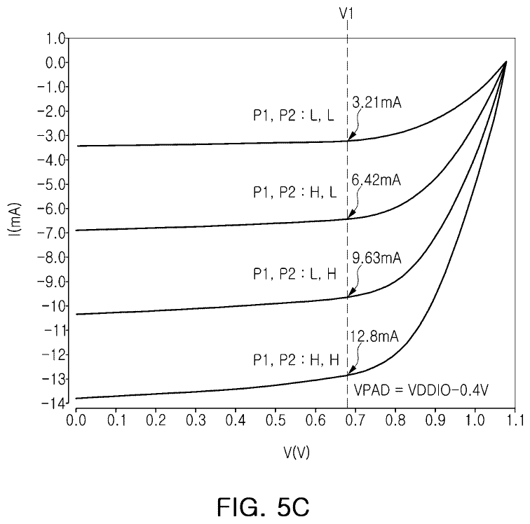

Referring to FIGS. 4A, 4B and 5A, the driving strength setting values (P1, P2) may be determined by four examples. In an example, when the driving strength setting values (P1, P2) are L (low), L, the first driving semiconductor circuit elements (MN11, MP11) may be in an on state, and the second driving semiconductor circuit elements (MN12, MP12) and the third driving semiconductor circuit elements (MN13, MP13) may be in an off state. Accordingly, the driving strength may be 1 and the driving current (X1) may be the smallest.

In an example, when the driving strength setting values (P1, P2) are L, H (high), the first driving semiconductor circuit elements (MN11, MP11) and the second driving semiconductor circuit elements (MN12, MP12) may be in an on state, and the third driving semiconductor circuit elements (MN13, MP13) may be in an off state.

Alternatively, depending on an implementation, when the driving strength setting values (P1, P2) are L, H (high), the first driving semiconductor circuit elements (MN11, MP11) and the second driving semiconductor circuit elements (MN12, MP12) may be in an off state, and the third driving semiconductor circuit elements (MN13, MP13) may be in an on state. Accordingly, the driving strength may be 2.

In an example, when the driving strength setting values (P1, P2) are H, L, the first driving semiconductor circuit elements (MN11, MP11) and the third driving semiconductor circuit elements (MN13, MP13) may be in an on state, and the second driving semiconductor circuit elements (MN12, MP12) may be in an off state. Accordingly, the driving strength may be 3.

In an example, when the driving strength setting values (P1, P2) are H, H, the first driving semiconductor circuit elements (MN11, MP11), the second driving semiconductor circuit elements (MN12, MP12), and the third driving semiconductor circuit elements (MN13, MP13) may be in an on state. Accordingly, the driving strength may be 4, and a driving current (X4) may be the largest.

The difference between a driving current (X2) according to a driving strength of 2 and a driving current (X3) according to a driving strength of 3 may be implemented as the size (W/L) of each of the third driving semiconductor circuit elements (MN13, MP13) larger than the size (W/L) of each of the second driving semiconductor circuit elements (MN12, MP12).

In an example, a size of each of the third driving semiconductor circuit elements (MN13, MP13) may be 1.6 times or more and 2.4 times or less (median: 2 times) than a size of each of the first driving semiconductor circuit elements (MN11, MP11), and may be 1.6 times or more and 2.4 times or less (median: 2 times) than a size of each of the second driving semiconductor circuit elements (MN12, MP12). The size of each of the first driving semiconductor circuit elements (MN11, MP11) may be 0.8 times or more and 1.2 times or less (median: 1) than the size of each of the second driving semiconductor circuit elements (MN12, MP12). Accordingly, the driving current (X1) according to a driving intensity of 1, the driving current (X2) according to a driving intensity of 2, the driving current (X3) according to a driving intensity of 3, and the driving current (X4) according to a driving intensity of 4 may have a close to linear relationship with each other. A linear relationship means that the slope of the change in driving current may be constant as the driving intensity value changes.

A horizontal axis of FIG. 5B and FIG. 5C represents the voltage (VPAD) of the driving coil (L) of FIG. 3B, a vertical axis of FIG. 5B represents the driving current of a N-type driving semiconductor circuit elements (MN11, MN12, MN13) excluded from a P-type driving semiconductor circuit elements (MP11, MP12, MP13) of FIG. 4A and FIG. 4B, and the vertical axis of FIG. 5C represents the driving current of the P-type driving semiconductor circuit elements (MP11, MP12, MP13) excluded from the N-type driving semiconductor circuit elements (MN11, MN12, MN13) of FIG. 4A and FIG. 4B.

Referring to FIG. 5B, an increase slope of the driving current (7.26 mA, 14.5 mA, 21.1 mA, 28.4 mA) according to an increase in the driving strength setting value (P1, P2) of the N-type driving semiconductor circuit elements (MN11, MN12, MN13) may be almost linear. An increase slope of the driving current (3.21 mA, 6.42 mA, 9.63 mA, 12.8 mA) according to the increase in the driving strength setting value (P1, P2) of the P-type driving semiconductor circuit elements (MP11, MP12, MP13) may be almost linear.

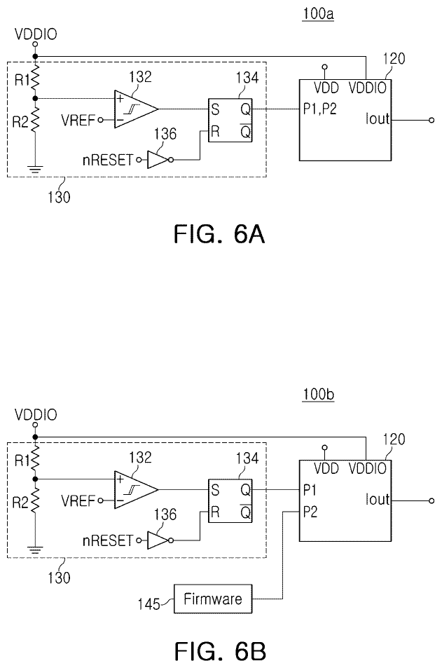

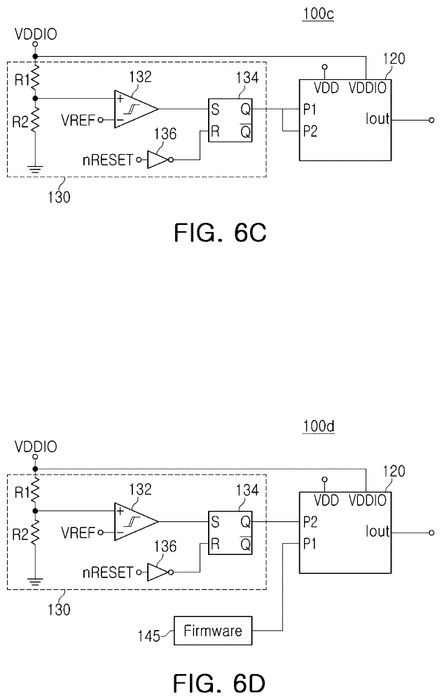

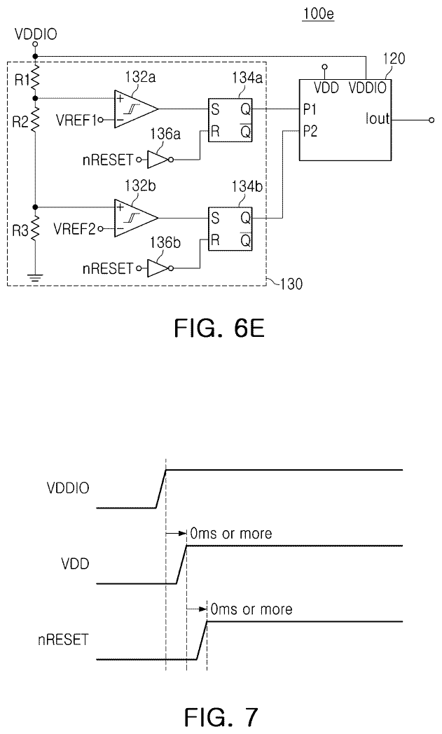

Referring to FIGS. 6A to 6E, the driving strength optimizer (130) of the camera module driving IC (100a) of the camera module driving apparatus, in accordance with one or more embodiments, may include the comparator (132) and the latch (134), and may further include the plurality of resistors (R1, R2) and an inverter (136).

The comparator (132) may sense the voltage of the power supply (VDDIO) and output a value based on the sensed result. In an example, the comparator (132) may be implemented based on an operational amplifier.

The latch (134) may receive a value according to the sensed result and output the driving strength setting value (P1, P2) of the driver (120). The latch (134) may have multiple input terminals (S, R) and may have an output terminal (Q). In an example, the latch (134) may be implemented based on a plurality of NOR gates or may be implemented based on a plurality of NAND gates.

Referring to FIG. 6A and FIG. 7, when a value input to the input terminal (R) of the latch (134) is L (low) and a value input to the input terminal(S) of the latch (134) changes from L to H (high), a value of the output terminal (Q) may change from L to H. For example, when the power supply (VDDIO) increases from the first power supply (e.g., 1.2 V) to the second power supply (e.g., 1.8 V), the value input to the input terminal(S) may change from L to H.

Afterwards, if the value input to the input terminal (R) may not change, the value of the output terminal (Q) may be maintained even if the value input to the input terminal(S) changes from H to L. Accordingly, the latch (134) may cause the driving strength optimizer (130) to be in a paused state by maintaining the value of the output terminal (Q) until the value input to the input terminal (R) may be changed. In an example, the latch (134) may maintain the value of the output terminal (Q) regardless of the voltage of the power supply (VDDIO) until the value input to the input terminal (R) changes.

From the time at which the value input to the input terminal(S) of the latch (134) changes from L to H until the time at which the value input to the input terminal (R) changes, the driver (120) may stably perform the driving strength setting operation without being substantially affected by the driving strength optimizer (130).

The driver (120) may change a voltage of VDD terminal and change a voltage of nRESET terminal after terminating or stabilizing the driving strength setting operation. Accordingly, the value input to the input terminal (R) of the latch (134) may be changed. Accordingly, the drive strength optimizer (130) may be restarted.

The plurality of resistors (R1, R2) may reduce the voltage of the power supply (VDDIO) by a predetermined ratio and output it to the comparator (132). A given ratio may be determined by a resistance value relationship between the plurality of resistors (R1, R2). The comparator (132) may output a value based on the high-low relationship between a voltage output from multiple resistors (R1, R2) and a reference voltage (VREF) as a value according to the sensed result.

Referring to FIG. 7, a timing of the voltage change of the power supply (VDDIO) may be earlier than a timing of the voltage change of the VDD terminal, and a timing of the voltage change of the nRESET terminal may be later than the timing of the voltage change of the VDD terminal. Therefore, the voltage of the VDD terminal of FIG. 6A may be controlled to adjust a time of the paused state of the driving strength optimizer (130). For example, the voltage of the VDD terminal may be a time that is preset by a timer in the driver (120), or a time that is naturally determined by a load in the driver (120) during the driving strength setting operation process of the driver (120).

Referring to FIGS. 6B and 6D, the camera module driving IC (100b, 100d) of the camera module driving apparatus, in accordance with one or more embodiments, may further include firmware (145) setting a portion of the driving strength setting values (P1, P2) to preset values. Among the driving strength setting values (P1, P2), those set by firmware (145) may vary depending on an implementation.

Referring to FIG. 6C, the camera module driving IC (100c) of the camera module driving apparatus, in accordance with one or more embodiments, may unify the driving strength setting values (P1, P2).

Referring to FIG. 6E, the driving strength optimizer (130) of the camera module driving IC (100e) of the camera module driving apparatus, in accordance with one or more embodiments, may include a plurality of comparators (132a, 132b), a plurality of latches (134a, 134b), a plurality of inverters (136a, 136b), and a plurality of resistors (R1, R2, R3). The plurality of comparators (132a, 132b) may sense the voltage of the power supply (VDDIO) based on a plurality of different reference voltages (VREF1, VREF2). The plurality of latches (134a, 134b) may each output driving strength setting values (P1, P2).

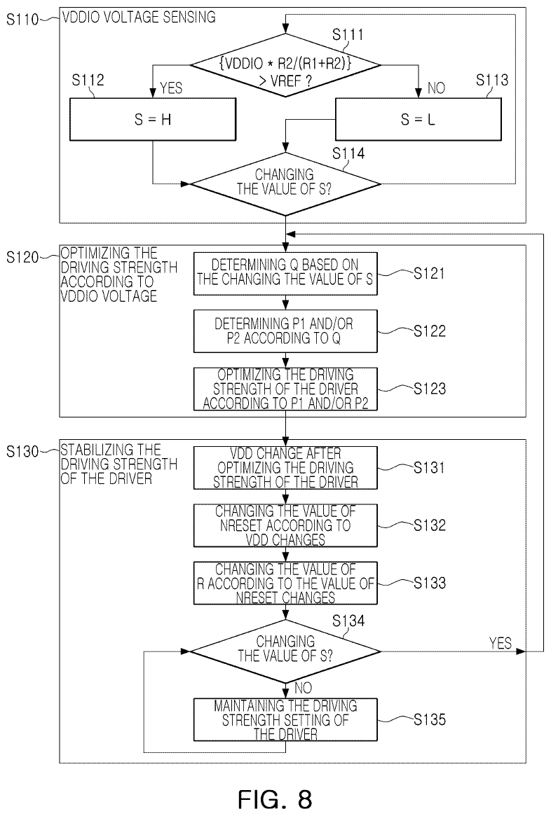

Referring to FIG. 8, a camera module driving apparatus and a device including a camera module, in accordance with one or more embodiments, may sequentially perform an operation (operation S110) of sensing the voltage of a power supply (VDDIO), an operation (operation S120) of optimizing the driving strength according to the voltage of the power supply (VDDIO), and an operation (operation S130) of stabilizing the driving strength of the driver.

In the operation (operation S110) of sensing the voltage of the power supply (VDDIO), the camera module driving apparatus and device may sense (operation S111) whether the value obtained by multiplying the voltage of the power supply (VDDIO) by a predetermined ratio (R2/(R1+R2)) based on the resistance values of the plurality of resistors is greater than the reference voltage (VREF). When the voltage of the power supply (VDDIO) is high, the value of the input terminal(S) of the latch may be H (operation S112), and when the voltage of the power supply (VDDIO) is low, the value of the input terminal(S) of the latch may be L (operation S113). Thereafter, depending on whether the value of the input terminal(S) of the latch may have changed, a determination of whether to proceed with the driving strength optimizing operation (operation S120) may be determined (operation S114).

In the operation (operation S120) of optimizing the driving strength according to the voltage of the power supply (VDDIO), the camera module driving apparatus and device may determine (operation S121) the output terminal (Q) of the latch based on whether the value of the input terminal(S) of the latch may have changed, determine (operation S122) the driving strength setting value (P1 and/or P2) according to the output terminal (Q) of the latch, and optimize (operation S123) the driving strength of the driver based on the driving strength setting value (P1 and/or P2).

In a driving strength stabilization operation (operation S130) of the driver, the camera module driving apparatus and device may change VDD voltage (operation S131) after optimizing the driving strength of the driver, change the value of the nRESET terminal according to the change in VDD voltage (S132), and change the value of the input terminal (R) of the latch according to the change in the value of the nRESET terminal (operation S133). Thereafter, depending on the value of the input terminal(S) of the latch change, the driving strength setting of the driver may be maintained (operation S135) or whether the operation of sensing the voltage of the power supply (VDDIO) (S110) may be performed (operation S134).

A camera module driving apparatus, in accordance with one or more embodiments, may stably optimize the driving strength of the driver according to a change in the voltage of the provided power supply.

In an example, the camera module driving apparatus may prevent a malfunction during the driving strength optimization process, may be robust against temporary instability of power provided during the driving strength optimization process, and may stably increase a degree of freedom of the provided power.

In an example, the camera module driving apparatus may stably address instability in the power supply configuration outside the camera module driving IC, may be advantageous in miniaturizing the camera module driving IC, and may stably improve the operational stability/efficiency of the camera module driving IC.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module driving apparatus, comprising:
a camera module driving integrated circuit (IC) comprising a communication port, a driving port and a power port;
a driver configured to output a driving current based on a set driving strength in the camera module driving IC; and
a driving strength optimizer configured to sense a voltage of power provided to at least one of the communication port and the power port in the camera module driving IC, and configured to set the driver to have a driving strength corresponding to the voltage of the power,
wherein the driving strength optimizer is configured to be in a paused state while changing the setting of the driving strength of the driver, when the voltage of the power is changed such that the corresponding driving strength is changed.

2. The camera module driving apparatus of claim 1,
wherein the driving strength optimizer is configured to resume an operational state after being in the paused state.

3. The camera module driving apparatus of claim 2, wherein the driving strength optimizer comprises:
a comparator configured to sense the voltage of the power and output a value based on the sensed voltage; and
a latch configured to receive the output value based on the sensed voltage, and output a set value of the driving strength of the driver;
wherein the driving strength optimizer is configured to be paused based on a change in value that is based on the sensed voltage input through a first input terminal among a plurality of input terminals of the latch, and is configured to resume an operational state based on a value input through a second input terminal of the plurality of input terminals.

4. The camera module driving apparatus of claim 1, wherein the driving strength optimizer comprises:
a comparator configured to sense the voltage of the power and output a value based on the sensed voltage; and
a latch configured to receive the value based on the sensed voltage, and output a set value of the driving strength of the driver;
wherein the driving strength optimizer is configured to be paused based on a change in value that is based on the sensed voltage input through a first input terminal among a plurality of input terminals of the latch.

5. The camera module driving apparatus of claim 4,
wherein the driving strength optimizer further comprises a plurality of resistors configured to reduce the voltage of the power by a predetermined ratio and output the reduced voltage of the power to the comparator, and
wherein the comparator is configured to output a value based on a high-low relationship between a voltage output from the plurality of resistors and a reference voltage, as the output value based on the sensed voltage.

6. The camera module driving apparatus of claim 1, further comprising:
an interface configured to receive a communication signal through the communication port of the camera module driving IC,
wherein the interface is configured to transmit a communication signal through the communication port based on the driving current of the driver, and
wherein the driving strength optimizer is configured to sense the voltage of the power provided to the communication port.

7. The camera module driving apparatus of claim 1, further comprising:
an interface configured to receive a communication signal through the communication port of the camera module driving IC; and
a controller configured to control the driving current of the driver based on the received communication signal,
wherein the driver is configured to output the driving current in which a ratio that is based on the set driving strength is applied to a current value determined by the controller.

8. The camera module driving apparatus of claim 1, wherein the driver comprises:
first driving semiconductor circuit elements coupled in a bridge structure; and
second driving semiconductor circuit elements coupled in a bridge structure;
wherein the driver is configured to switch between an operation of at least one of the first driving semiconductor circuit elements and the second driving semiconductor circuit elements, based on the set driving strength.

9. The camera module driving apparatus of claim 8,
wherein a size (W/L) of each of the first driving semiconductor circuit elements is larger than a size (W/L) of each of the second driving semiconductor circuit elements.

10. The camera module driving apparatus of claim 1, wherein the driver comprises:
first driving semiconductor circuit elements coupled in a bridge structure;
second driving semiconductor circuit elements coupled in a bridge structure; and
third driving semiconductor circuit elements coupled in a bridge structure;
wherein the driver is configured to switch between an operation of at least two of the first driving semiconductor circuit elements, the second driving semiconductor circuit elements, and the third driving semiconductor circuit elements, based on the set driving strength,
wherein a size of each of the third driving semiconductor circuit elements is 1.6 times or more and 2.4 times or less than a size of each of the first driving semiconductor circuit elements, and 1.6 times or more and 2.4 times or less than a size of each of the second driving semiconductor circuit elements, and
wherein the size of each of the first driving semiconductor circuit elements is 0.8 times or more and 1.2 times or less than the size of each of the second driving semiconductor circuit elements.

11. The camera module driving apparatus of claim 10,
wherein, in the driver, when set to have a first driving strength, a first set of the first driving semiconductor circuit elements or the second driving semiconductor circuit elements is turned on, a second set of the first driving semiconductor circuit elements or the second driving semiconductor circuit elements is turned off, and the third driving semiconductor circuit elements are turned off,
wherein when set to have a second driving strength, the first driving semiconductor circuit elements and the second driving semiconductor circuit elements are turned on, and the third driving semiconductor circuit elements are turned off, or the first driving semiconductor circuit elements and the second driving semiconductor circuit elements are turned off, and the third driving semiconductor circuit elements are turned on,
wherein when set to have a third driving strength, a first set of the first driving semiconductor circuit elements or the second driving semiconductor circuit elements is turned on, a second set of the first driving semiconductor circuit elements or the second driving semiconductor circuit elements is turned off, and the third driving semiconductor circuit elements are turned on, and
wherein when set to have a fourth driving strength, the first driving semiconductor circuit elements, the second driving semiconductor circuit elements, and the third driving semiconductor circuit elements are turned on.

12. A camera module driving apparatus, comprising:
a camera module driving integrated circuit (IC) comprising a communication port, a driving port and a power port;
a driver configured to output a driving current based on a set driving strength in the camera module driving IC; and
a driving strength optimizer configured to sense a voltage of power provided to at least one of the communication port and the power port in the camera module driving IC, and configured to set the driver to have a driving strength corresponding to the voltage of the power,
wherein the driving strength optimizer comprises:
a comparator configured to sense the voltage of the power and output a value based on the sensed voltage; and
a latch configured to receive the output value based on the sensed voltage, and output a set value of the driving strength of the driver.

13. The camera module driving apparatus of claim 12,
wherein the driving strength optimizer further comprises a plurality of resistors configured to reduce the voltage of the power by a predetermined ratio and output the reduced voltage of the power to the comparator, and
wherein the comparator is configured to output a value based on a high-low relationship between a voltage output from the plurality of resistors and a reference voltage as the output value based on the sensed voltage.

14. The camera module driving apparatus of claim 12, further comprising:
an interface configured to receive a communication signal through the communication port of the camera module driving IC,
wherein the interface is configured to transmit a communication signal through the communication port based on the driving current of the driver, and
wherein the driving strength optimizer is configured to sense the voltage of the power provided to the communication port.

15. The camera module driving apparatus of claim 12, further comprising:
an interface configured to receive a communication signal through the communication port of the camera module driving IC; and
a controller configured to control the driving current of the driver based on the received communication signal;
wherein the driver is configured to output the driving current in which a ratio that is based on the set driving strength is applied to a current value determined by the controller.

16. The camera module driving apparatus of claim 12, wherein the driver comprises:
first driving semiconductor circuit elements coupled in a bridge structure; and
second driving semiconductor circuit elements coupled in a bridge structure,
wherein the driver is configured to switch between an operation of at least one of the first driving semiconductor circuit elements and the second driving semiconductor circuit elements, based on the set driving strength.
